(19) United States
(12) Patent Application Publication
(10) Pub. No.: US 2020/0248765 A1
(43) Pub. Date: Aug. 6, 2020

(54) HYDRAULICALLY COOLED SPHERE DRIVE LINE RETARDER

(71) Applicant: Lewis Designs, LLC, Waterford, PA (US)

(72) Inventor: Aaron J. Lewis, Erie, PA (US)

(73) Assignee: Lewis Designs, LLC, Waterford, PA (US)

(21) Appl. No.: 16/636,506

(22) PCT Filed: Aug. 3, 2018
(86) PCT No.: PCT/US2018/045148

§ 371 Date: Feb. 4, 2020

Related U.S. Application Data
(60) Provisional application No. 62/541,523, filed on Aug. 4, 2017.

(51) Int. Cl. F16D 51/24; F16D 65/22

(52) U.S. Cl. CPC F16D 51/24; F16D 49/16; F16D 65/22

(57) ABSTRACT

A sphere drive line retarder is presented that is mounted to a drive shaft from an engine. The sphere drive line retarder comprises a sphere rotor mounted to the drive shaft and housed within a retarder housing. The sphere drive line retarded has a piston assembly comprising at least one piston, a brake shoe mounted to each piston, and hemispherical friction material mounted to the brake shoe. The hemispherical friction material is located between the sphere rotor and the brake shoe. Each piston is housed within a piston housing that is hydraulically isolated from the retarder housing. The retarder housing contains hydraulic fluid to cool the sphere rotor.

### BACKGROUND

Heavy vehicles, such as semis and buses sometimes use devices called retarders to augment or replace their primary braking systems which are typically located at the wheels of the vehicle. Retarders are primarily located along the drive line that powers the axles of the vehicle and are used to slow down the vehicle especially in situations where heavy loads may cause the vehicle to accelerate out of control, such as in steep inclines, declines, or in unsafe road conditions. What is presented is an improved drive line retarder that incorporates spherical braking systems.

### SUMMARY

A sphere drive line retarder is presented that is mounted to a drive shaft from an engine. The sphere drive line retarder comprises a sphere rotor mounted to the drive shaft and housed within a retarder housing. The sphere drive line retarded has a piston assembly comprising at least one piston, a brake shoe mounted to each piston, and hemispherical friction material mounted to the brake shoe. The hemispherical friction material is located between the sphere rotor and the brake shoe. Each piston is housed within a piston housing that is hydraulically isolated from the retarder housing. The retarder housing contains hydraulic fluid that cools the sphere rotor.

A two-way bleeder valve port may be mounted to the retarder housing. The drive shaft is typically connected to a differential that is connected to drive axles. A PLC may be incorporated to control the activation of the piston assembly. A sight glass may be located on the retarder housing to enable checking of the level of hydraulic fluid within the sphere drive line retarder.

The piston assembly actuates to press the hemispherical friction material against the sphere rotor. In various embodiments, the piston assembly is actuated by one of hydraulic power, pneumatic power, mechanical power, and electric power. In other embodiments, the piston assembly comprises two pistons.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a schematic showing where the hydraulically cooled drive line retarder would be installed in a vehicle;

FIG. 2 is a perspective view of one embodiment of the hydraulically cooled drive line retarder; and

FIG. 3 is an exploded view of the hydraulically cooled drive line retarder of FIG. 2.

### DETAILED DESCRIPTION

Referring to the drawings, some of the reference numerals are used to designate the same or corresponding parts through several of the embodiments and figures shown and described. Variations of corresponding parts in form or function that are depicted in the figures are described. It will be understood that variations in the embodiments can generally be interchanged without deviating from the invention.

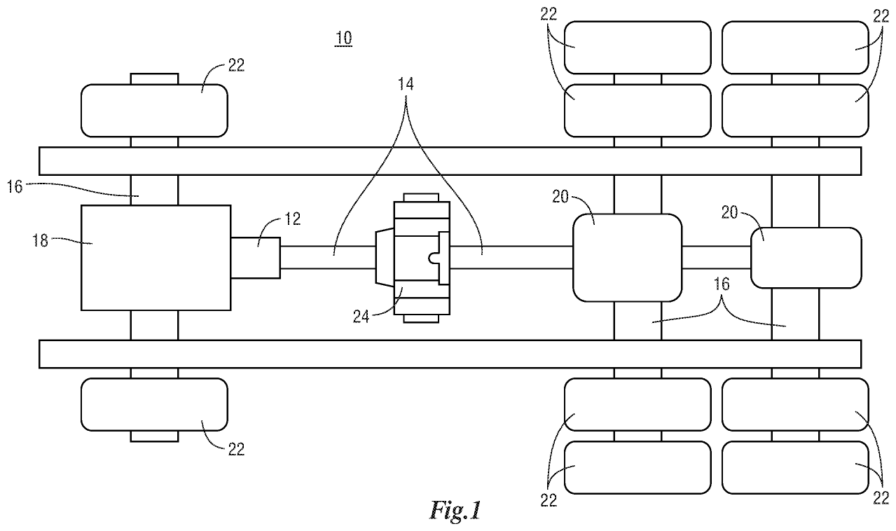

FIG. 1 shows a schematic of the chassis of a vehicle 10. The powertrain of a vehicle is everything that makes the vehicle 10 move including the transmission 12, the drive shaft or drive line 14, and the axles 16. The transmission 12 is connected to the engine 18 to transmit the mechanical power from the engine 18. The drive shaft 14 links the transmission 12 to the axles 16. Differentials 20 at each axle 16 provide power to the wheels 22. The wheels 22 are mounted to the axles 16. Most vehicles have braking system located at the wheels 22 which are actuated by the driver to slow down the movement of the vehicle 10. In many larger vehicles, especially those that pull large loads or that require additional stopping or slowing power, drive line retarders are installed to augment the truck's primary braking system located at the vehicle's wheel ends.

An improved drive line retarder is presented in which the retarder is a sphere drive line retarder 24. One of the problems faces by typical drive line retarders is that because they are located within center of the vehicle 10, they are not as easy to cool as wheel end brakes that are located at the wheels 22. Wheel end brakes are typically air-cooled whereas drive line retarders are not so easily cooled. The drive line retarder 24 presented herein solves this problem by using a hydraulic fluid as a coolant as described herein. Hydraulic fluids that may be used include transmission fluid, brake fluid, power steering fluid, or other hydraulic fluids that are common to the automotive industry so long as it serves the purpose of a coolant to remove heat generated from the operation of the drive line retarder 24.

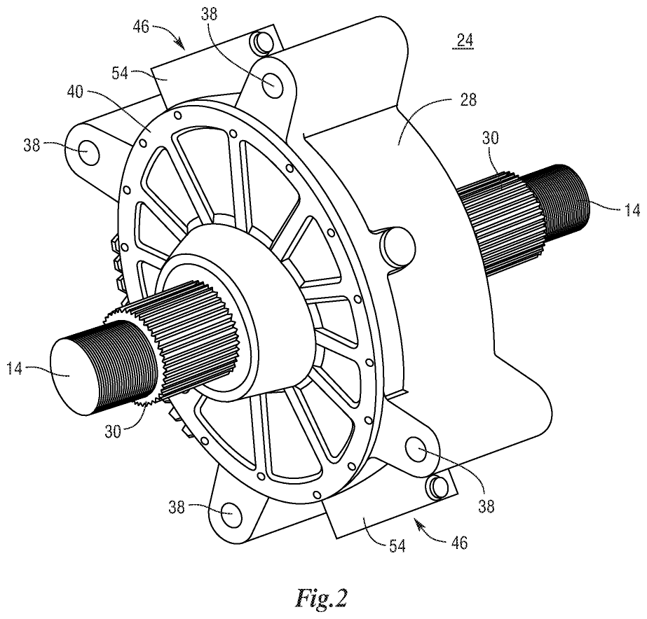

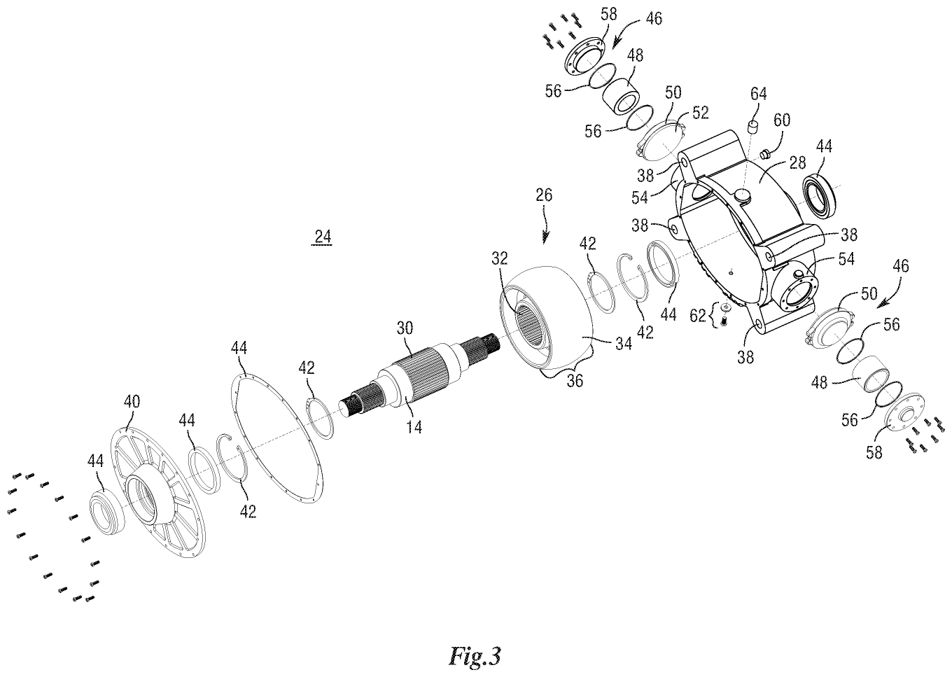

As best understood by comparing FIGS. 2 and 3, the sphere drive line retarder 24 is mounted to the drive shaft 14 onto which a sphere rotor 26 is mounted. The sphere rotor 26 is housed within a retarder housing 28. The drive shaft 14 has outer teeth 30 that correspond to inner teeth 32 located on the inner surface of the sphere rotor 26. The outer surface 34 of sphere rotor 26 has an angular coverage between 1 and 180 degrees of the sphere rotor 26. The portion of the outer surface 34 that is used to slow down the sphere rotor 26 has an angular coverage between 1 and 180 degrees of the sphere rotor 26. The sphere arc 36 is between 1 and 359 degrees of the drive shaft 14.

The sphere rotor 26 is preferably constructed from metallic material. The frame mounting holes 38 allow the retarder housing 28 to mount to the chassis of the vehicle 10. The drive shaft 14 slides into the sphere rotor 26 and is held in place within the retarder housing 28 with a main housing cap 40 and a number of retaining clips 42 and bearing seals 44.

The rotation of the sphere rotor 26 is slowed by the application of pressure against the outer surface 34 by a piston assembly 46 that comprises at least one piston 48 and its appurtenances. In the embodiment shown in the figures, the piston assembly 46 comprises two pistons 48 mounted on opposite sides of the sphere rotor 26. A brake shoe 50 is mounted to each piston 48. Hemispherical friction material 52 is mounted inside each brake shoe 50. The hemispherical friction material 52 is located between the sphere rotor 26 and the brake shoe 50. The hemispherical friction material 52 is shaped to conform to the curve of the sphere rotor 26.

Each piston 48 housed within a piston housing 54 that is hydraulically isolated from the retarder housing 28. The embodiment shown in the figures shows hydraulically activated pistons. In this embodiment, hydraulic fluid that operates the pistons is sealed inside the piston housing 54 with hydraulic seals 56 and secured in place by piston caps 58. Those of ordinary skill will understand that the piston assembly 46 may be actuated by other means such as pneumatic power, mechanical power, or electric power. In other embodiments that have different types of piston assemblies, the hydraulic seals 56 are still used to keep the retarder housing 28 hydraulically isolated as discussed below.

The retarder housing 28 is hydraulically isolated from the piston assembly 46 and is filled with a hydraulic fluid to serve as a coolant for the sphere rotor 26. Hydraulic fluids that may be used include transmission fluid, brake fluid, power steering fluid, or other hydraulic fluids that are common to the automotive industry so long as it serves the purpose of a coolant to remove heat generated from the operation of the drive line retarder 24. A sight glass 60 is installed on the side of the retarder housing 28 to determine appropriate level of hydraulic fluid. A drain plug and seal 62 are located on the bottom of the housing to drain fluid. A fill cap 64 is used to fill the retarder housing 28 and act as a two-way bleeder valve port to circulate hydraulic fluid within the retarder housing 28 and relieve pressure that may build within the retarder housing 28.

A PLC (not shown) is used to control activation of the system. Sphere drive line retarders 24 with hydraulically powered piston assemblies 46 as shown in the figures are activated by the driver in the cab of the vehicle using a brake switch that is powered by the vehicle battery (not shown). When the switch is activated, and the driver lets off the gas pedal, the PLC sends an electric signal to an electric over hydraulic pump mounted on the engine frame rail. The electric over hydraulic pump converts electric to hydraulic force by pressurizing hydraulic fluid lines through a two-way splitter valve that evenly distributes pressure to the piston caps 58 which actuates the pistons 48 against the brake shoes 50 which in turn pushes the hemispherical friction material 52 against the sphere rotor 26. This produces friction against the sphere rotor 26 which slows the drive shaft 14, subsequently slowing the axles 16 through the differential 20. When the driver presses the gas pedal, the retarder is deactivated through the PLC.

This invention has been described with reference to several preferred embodiments. Many modifications and alterations will occur to others upon reading and understanding the preceding specification, it is intended that the invention he construed as including all such alterations and modifications in so far as they come within the scope of the appended claims or the equivalents of these claims.

What is claimed is:

1. A sphere drive line retarder mounted to a drive shaft from an engine, the sphere drive line retarder comprising:
a sphere rotor mounted to the drive shaft and housed within a retarder housing;
a piston assembly comprising:
at least one piston;
a brake shoe mounted to each said piston;
hemispherical friction material mounted to said brake shoe;
said hemispherical friction material is located between said sphere rotor and said brake shoe; and
each said piston housed within a piston housing that is hydraulically isolated from said retarder housing; and
said retarder housing containing hydraulic fluid and the hydraulic fluid cools said sphere rotor.

2. The sphere drive line retarder of claim 1 in which said piston assembly actuates to press said hemispherical friction material against said sphere rotor.

3. The sphere drive line retarder of claim 1 in which said piston assembly is actuated by one of hydraulic power, pneumatic power, mechanical power, and electric power.

4. The sphere drive line retarder of claim 1 in which said piston assembly comprises two said pistons.

5. The sphere drive line retarder of claim 1 further comprising a two-way bleeder valve port mounted to said retarder housing.

6. The sphere drive line retarder of claim 1 in which the drive shaft is further connected to a differential that is connected to drive axles.

7. The sphere drive line retarder of claim 1 further comprising a PLC to control the activation of said piston assembly.

8. The sphere drive line retarder of claim 1 further comprising a sight glass located on said retarder housing.
